(19) United States
(12) Patent Application Publication
(10) Pub. No.: US 2024/0247701 A1
(43) Pub. Date: Jul. 25, 2024

(54) NON-RETURN VALVE, VIBRATION DAMPER HAVING SUCH A NON-RETURN VALVE, AND USE OF SUCH A NON-RETURN VALVE

(71) Applicants: thyssenkrupp Bilstein GmbH, Ennepetal (DE); thyssenkrupp AG, Essen (DE)

(72) Inventors: Nicolas SUMKOETTER, Wadersloh (DE); Tim NORUSCHAT, Wuppertal (DE); Adrian HASSEL, Reichshof-Nosbach (DE)

(73) Assignees: thyssenkrupp Bilstein GmbH, Ennepetal (DE); thyssenkrupp AG, Essen (DE)

(21) Appl. No.: 18/418,013

(22) Filed: Jan. 19, 2024

(30) Foreign Application Priority Data
Jan. 23, 2023 (DE) 10 2023 101 557.5

(51) Int. Cl. F16F 9/348

(52) U.S. Cl. CPC F16F 9/3482

(57) ABSTRACT

A non-return valve for a vibration damper having a valve body having at least two control edges which are offset from one another in terms of height and at least one flow channel formed between the control edges, at least one cover disc, which covers the flow channel in a shut-off state of the non-return valve and at least one spring element lying against the cover disc, wherein the spring element elastically deforms the cover disc from the first, in particular higher, control edge in such a way that the cover disc lies sealingly against the second, in particular lower, control edge.

### CROSS REFERENCE TO RELATED APPLICATION

This application is a U.S. Non-Provisional that claims priority to German Patent Application No. DE 10 2023 101 557.5, filed Jan. 23, 2023, and the entire content of which is incorporated herein by reference.

### FIELD

The disclosure relates to a non-return valve, to a vibration damper having a non-return valve, and to the use of a non-return valve.

### BACKGROUND

A generally known field of application for non-return valves is vibration dampers for vehicles. The non-return valves are used, among other things, to open up or shut off a flow path of the damping fluid between piston working chambers during a compression stage or rebound stage of the vibration damper. To this end, a respective non-return valve can be provided for the compression stage and the rebound stage. In particular, the non-return valves serve to fill the piston working chambers when the volume of the latter increases.

Various types of valves with a non-return function are known from the prior art. For example, such valves may comprise two control edges with a cover disc arranged thereon. The cover disc can block or open up a flow path. The control edges are frequently formed in a plane, with the result that the cover disc lies tightly against the control edges in the shut-off state. However, this has the disadvantage that, in the event of a change from the open state of the valve to the shut-off state, the cover disc impacts the control edges at the same time and the result is therefore an increased switching noise. In addition, such valves have a poor dynamic response behaviour.

DE 10 2017 207 605 A1, which was mentioned in the introduction, discloses a further valve in the form of a damping valve, which utilizes a non-return principle for vibration damping. The damping valve has multiple control edges which lie at different height levels. The result of this is an improved shut-off behaviour and the reduction of switching noises, since the cover disc makes contact with the control edges in succession, i.e. not at the same time.

In the case of the damping valve, multiple valve discs are arranged on the cover disc, wherein the cover disc is pressed onto the control edges by the valve discs via a screw nut. As a result, the cover disc lies tightly against the control edges. In the case of the damping valve, however, it is disadvantageous that a relatively high opening pressure of the damping fluid is necessary to lift the cover disc off from the control edges. The valve therefore has a correspondingly sluggish response behaviour, in particular in the event of low volumetric flows of the damping fluid.

Thus a need exists for specifying a non-return valve for a vibration damper which has an improved response behaviour with reduced switching noises. The disclosure also includes a vibration damper having a non-return valve and the use of such a non-return valve.

### BRIEF DESCRIPTION OF THE FIGURES

Further advantageous details, features and details of the disclosure will be explained in more detail in the context of the exemplary embodiments illustrated in the figures, in which:

FIG. 1 shows a longitudinal section through a vibration damper having two non-return valves according to the disclosure.

FIG. 2 shows a perspective view of a valve body of the non-return valve of FIG. 1.

FIG. 3 shows a plan view of the valve body of FIG. 2.

FIG. 4 shows a longitudinal section through one of the two non-return valves of FIG. 1.

FIG. 5 shows a longitudinal section through the valve body of FIGS. 2 and 3.

FIG. 6 shows a detail of the longitudinal section through the valve body of FIG. 5 in a first region of control edges of the valve body.

FIG. 7 shows another detail of the longitudinal section through the valve body of FIG. 5 in a second region of control edges of the valve body.

FIG. 8 shows a detail of a longitudinal section through the valve body of a non-return valve of a vibration damper according to the disclosure.

FIG. 9 shows a flat view of a cover disc of the non-return valve according to FIG. 1 and of the non-return valve according to FIG. 8.

FIG. 10 shows a flat view of a bypass disc of the non-return valve according to FIG. 8.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

A non-return valve for a vibration damper is disclosed. The non-return valve including the following:
a valve body having at least two control edges which are offset from one another in terms of height and at least one flow channel formed between the control edges;
at least one cover disc, which covers the flow channel in a shut-off state of the non-return valve; and
at least one spring element lying against the cover disc.
   According to the disclosure, the spring element elastically deforms the cover disc from the first, in particular higher, control edge in such a way that the cover disc lies sealingly against the second, in particular lower, control edge.

The disclosure has various advantages. Owing to the two height-offset control edges, the non-return valve exhibits reduced switching noises when actuated, i.e. when the cover disc is being raised and lowered. The cover disc is raised and put down on the control edges in succession owing to the height offset.

During an opening operation, the cover disc lifts off first of all from the second control edge and then from the first control edge. In this state, the cover disc is spaced apart from the two control edges. It is alternatively possible for the cover disc to lift off from the second control edge but still be in contact with the first control edge. This can be the case in the event of very low volumetric flows or a low opening pressure owing to a fluid, in particular damping fluid, present in the flow channel. In both cases, the cover disc is in an open position, in which the flow channel for the fluid is opened up. In particular when the non-return valve is used for bypass regulation between two piston working chambers of a vibration damper, this makes it possible for the fluid to flow from one piston working chamber to the other when there is an increase in the working chamber volume, depending on a compression stage or rebound stage.

During a closing operation, the spring element arranges the cover disc on the control edges again counter to the opening direction. During the closing process, the cover disc first lies on the first control edge. During the closing operation, the first control edge forms a first support, preferably for a first subregion of the cover disc. The first control edge at least partially delimits the closing travel of the cover disc. The first control edge is preferably higher than the second control edge in the opening direction. The spring element then elastically deforms the cover disc in such a way that the cover disc lies tightly against the second control edge. The second control edge forms a second support, preferably for a second subregion of the cover disc. The second control edge terminates the closing travel. In this state, the cover disc is in a closed position, in which the flow channel for a fluid is shut off, in particular completely blocked. The closed position of the cover disc corresponds to the shut-off state of the non-return valve, in which the cover disc lies sealingly against the two control edges.

The cover disc makes contact with the two control edges in succession during the closing operation. This results in rolling when the cover disc is being closed, this having a positive effect on the generation of switching noise. The cover disc can lie against the control edges directly in the shut-off state of the non-return valve. The cover disc can alternatively lie against the control edges indirectly in the shut-off state of the non-return valve. To this end, at least one intermediate element, in particular a bypass disc, may be arranged between the cover disc and the control edges.

The height offset of the two control edges corresponds to a deformation travel of the cover disc, over the length of which the spring element elastically deforms the cover disc. As a result of the elastic deformation of the cover disc over the length of the deformation travel, the cover disc builds up a disc force which acts counter to a spring force of the spring element.

The disclosure therefore has the further considerable advantage that the opening force necessary for the opening operation, or lifting the cover disc off from the control edges, is reduced. The opening force corresponds to the difference between the spring force of the spring element and the disc force of the cover disc. The cover disc is therefore preferably adapted such that, in the deformed state, it applies a disc force that counteracts the spring force of the spring element. During an opening operation and closing operation, the cover disc advantageously reacts quickly and precisely to different pressures of the fluid located in the flow channel. In particular, owing to the reduced opening force, a precise and quick reaction to small and pulsed volumetric flows is realized. The non-return valve therefore has an improved response behaviour overall.

The disc force of the cover disc reduces not only the opening force required. The disc force that builds up over the deformation travel of the cover disc additionally brakes the cover disc during the closing process, i.e. when it is being placed on the second control edge. This considerably reduces the switching noise level of the non-return valve.

Preferred embodiments of the disclosure are specified in the dependent claims.

In a preferred embodiment, the valve body has an inwardly recessed bottom surface, from which the control edges rise. In other words, the bottom surface is integrated in the valve body, wherein the bottom surface is recessed from an outer contour into the valve body. The control edges are therefore likewise advantageously integrated in the valve body. The non-return valve has a compact structure as a result.

The first control edge preferably projects above the second control edge proceeding from the bottom surface. In other words, the first control edge is formed higher in relation to the bottom surface than the second control edge. The first control edge may be formed radially on the inside or radially on the outside of the second control edge. Or, expressed differently, the second control edge may be radially on the inside or radially on the outside of the first control edge. The term “radially” relates to the position of the control edges transversely to a centre axis of the valve body. The first control edge can therefore be closer to the centre axis of the valve body than the second control edge is in the radial direction. In this embodiment, the non-return valve has increased design versatility. The non-return valve can therefore be configured specifically for the application.

The valve body preferably has at least one central through-opening for the fluid, in particular damping fluid, wherein the control edges encircle the through-opening. The central through-opening can form a further flow channel for the fluid. Advantageously, this makes it possible to use the non-return valve with further valve systems, for example an adjusting valve for the in particular dynamic setting of the damping of a vibration damper. The annular form of the control edges simplifies the construction of the valve body and ensures uniform force distribution in the cover disc.

In a preferred embodiment, the valve body has a recess in which the cover discs and the spring element are arranged, wherein the control edges project into the recess. The recess is preferably an indentation in the valve body. The recess is preferably outwardly open, in particular in the longitudinal direction of the centre axis. The recess is inwardly preferably at least partially delimited by the bottom surface. The recess advantageously provides space for receiving a functional element, for example the spring element, the cover disc or the like. Furthermore, the recess serves as a flow chamber, which connects the flow channel and the central through-opening, in the open position of the cover disc.

The non-return valve preferably has at least one insert element, in particular a support ring, which is arranged in the recess and forms a counter-bearing for the spring element. The insert element serves to assist the spring element in applying the spring force to the cover disc. The insert element is preferably positionally fixedly arranged in the recess. By virtue of the arrangement integrated in the recess, the non-return valve has a particularly compact design.

The valve body preferably has at least one first sealing region, which encircles the recess and is intended to provide sealing with respect to a mating piece, in particular an adjusting valve. In the mounted state, the non-return valve can thus be sealed with respect to the mating piece. This increases the operational reliability of the non-return valve. The first sealing region may be formed on a first end face of the valve body. The first sealing region may comprise a slot which encircles the recess and receives a sealing element, in particular an O ring.

The valve body may have at least one collar, which is arranged on a circumference of the valve body and at least partially extends in the circumferential direction. The collar advantageously extends radially outwards. This provides a support region which simplifies a fixed installation of the non-return valve. In particular, the valve body may have a circumferentially extending collar with multiple cutouts. The collar may form a star-shaped outer contour of the valve body.

The valve body preferably has at least one elevation, in particular a support ridge, which is arranged between the control edges, wherein the elevation delimits a deformation travel of the cover disc. The elevation is preferably formed on the bottom surface between the control edges. In the closed position of the covering disc, the elevation prevents deformation of the cover disc towards the bottom surface, specifically between the control edges. The elevation therefore serves as a connection piece for the cover disc. The valve body particularly preferably has a multiplicity of elevations which are distributed evenly in the circumferential direction.

The elevation preferably rises from the second control edge towards the first control edge, wherein the elevation extends below a reference line which connects the highest points of the control edges. The highest points of the control edges are understood to mean vertices and/or apex surfaces of the control edges at which the cover disc lies against the control edges in the closed position. The reference line forms a straight line between the vertices and/or apex surfaces. With particular preference, the elevation always lies below the reference line between the control edges, with the result that the switching behaviour remains substantially unaffected.

The elevation preferably performs a safety function which assists the cover disc at elevated fluid pressures.

In one embodiment, the valve body has at least one extension which extends along a centre axis of the valve body and at the longitudinal end of which at least one second sealing region is formed. In other words, in this case the valve body has a peg with a second sealing region at its longitudinal end. The extension advantageously provides a port for sealed connection for example to a piston working chamber of the vibration damper. The second sealing region may comprise a slot which encircles the recess and receives a sealing element, for example an O ring.

The spring element may lie against a surface of the cover disc that is situated opposite the control edges, wherein the spring element introduces its spring force radially inwardly, radially outwardly and/or radially centrally into the cover disc. In other words, the spring element may lie with one spring end against the cover disc in a radially inner surface region, a radially outer surface region or a radially central surface region, in order to introduce the spring force into the cover disc. In this embodiment, the variant diversity of the non-return valve is increased.

The spring element preferably comprises a frustoconical spring, a barrel spring, a cylindrical spring and/or a plate spring. Other spring types are possible. In addition, the spring element may preferably be in the form of a compression spring or alternatively a tension spring. The cover disc may have a flat or frustoconical form in the non-deformed state. The cover disc is preferably annular, in particular circular.

In one embodiment, at least one bypass disc is arranged between the cover disc and the two control edges, wherein the bypass disc has at least one bypass channel which forms a passage to the flow channel in the shut-off state of the non-return valve. The bypass channel may be at least one bypass recess or at least one bypass opening. The bypass channel is preferable formed such that the flow channel is fluidically connected to the central through-opening of the valve body in the shut-off state of the non-return valve. The bypass channel of the bypass disc allows the fluid to flow between the interior space of the valve body and the flow channel during the closing and opening operations, i.e. when the cover disc is being raised and lowered, and also in the shut-off state of the non-return valve. This has a positive effect on the background noise when the non-return valve is actuated.

The bypass disc is preferably annular. The bypass channel may be formed radially on the inside. Here, the bypass channel connects the central through-opening of the valve body and the flow channel, in particular in the shut-off state of the non-return valve. The bypass channel may alternatively be formed radially on the outside. Here, the bypass channel connects the flow channel to the recess in the valve body in which the spring element is arranged.

According to an additional independent aspect, the disclosure relates to a vibration damper having at least one non-return valve according to the disclosure, wherein the non-return valve is arranged between at least two piston working chambers of the vibration damper and, during a compression stage and/or a rebound stage, fluidically connects the two piston working chambers to one another or shuts them off from one another.

In the case of a use according to the disclosure of at least one non-return valve in and/or on a vibration damper, the non-return valve is used or can be used in combination with at least one adjusting valve, at least one base valve, at least one rectifying valve arrangement and/or at least one valve flange, in particular an externally adapted valve system.

In terms of the vibration damper and the use according to the disclosure of the non-return valve, reference is made to the advantages set out in connection with the non-return valve. Furthermore, the vibration damper can alternatively or additionally have individual features or a combination of several of the features cited above in relation to the non-return valve.

In the following description, the same reference numbers are used for parts that are the same and have the same effect.

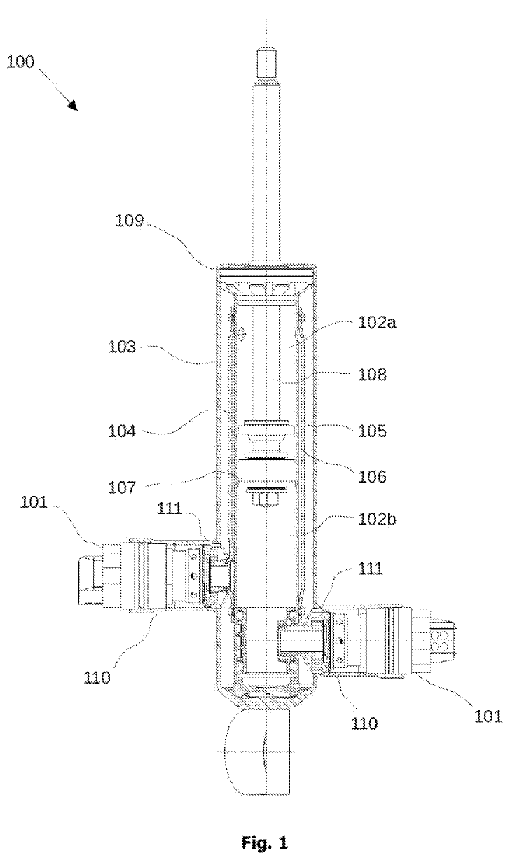

FIG. 1 shows a vibration damper 100 as per an exemplary embodiment according to the disclosure. The vibration damper 100 is in the form of a two-tube damper. Other damper configurations are possible. The vibration damper 100 has an outer tube 103 and an inner tube 104 arranged in the outer tube 103, the outer tube and inner tube being arranged coaxially. An annular space 105 in which an intermediate tube 106 is arranged is provided between the outer tube 103 and the inner tube 104. The intermediate tube 106 is likewise arranged coaxially. A piston 107, which subdivides an interior of the inner tube 104 into a first piston working chamber 102a and a second piston working chamber 102b, is arranged movably in the inner tube 104. The piston 107 is fastened to a piston rod 108, which dips into or moves out of the first piston working chamber 102a at a first longitudinal end 109 of the vibration damper 100 depending on a compression stage or rebound stage.

The vibration damper 100 has a total of two adjusting valves 101, which are arranged above a valve port 110 on the outer tube 103. The adjusting valves 101 serve to dynamically set the damping of the vibration damper 100. To channel the volumetric flow, for each adjusting valve 101 the vibration damper 100 comprises a non-return valve 10, which is inserted in the valve port 110. According to this exemplary embodiment, the vibration damper 100 therefore comprises a total of two non-return valves 10. The use of one non-return valve or more than two non-return valves 10 is alternatively possible, the application not being restricted to combination with the adjusting valves.

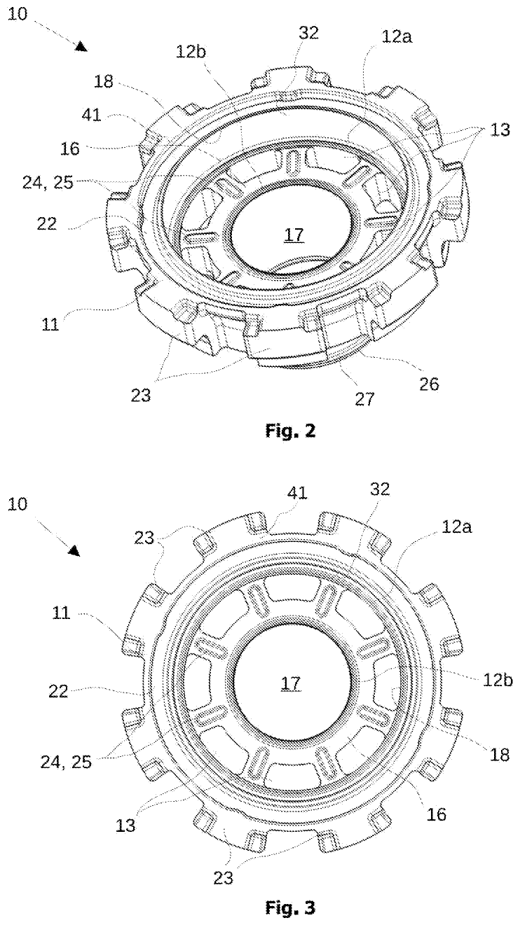

In the following description, one of the non-return valves 10 is explained in more detail with reference to FIGS. 2 to 7, the explanation also applying to the further non-return valve 10.

The non-return valve 10 has a valve body 11 with multiple flow channels 13 and a central through-opening 17. It can be clearly seen in FIGS. 2 and 3 that the flow paths 13 and the central through-opening 17 lead into the recess 18. The flow channels 13 form a free passage from an outer side of the valve body 11 into the recess 18. In the specific exemplary embodiment of the vibration damper 100 according to FIG. 1, the flow channels 13 lead from the annular space 105 into the recess 18 in the valve body 11.

The valve body 11 also comprises a centre axis M. The flow channels 13 and the central through-opening 17 extend substantially parallel in relation to the centre axis M. It is alternatively possible for at least the flow channels 13 to be able to run at an angle to the centre axis M. As can be clearly seen in FIG. 3, the flow channels 13 are distributed evenly around the centre axis M. The valve body 11 has a total of eight flow channels 13. However, the non-return valve 10 is not restricted to this number.

FIGS. 2 to 5 show that the valve body 11 comprises a recess 18. The recess 18 is cylindrical. The recess 18 makes the valve body 11 partially cup-shaped. The central through-opening 17 is likewise cylindrical. A non-cylindrical shape of the recess 18 and of the central through-opening 17 is possible. The flow channels 13, by contrast, have a substantially kidney-shaped cross section. Other shapes of the flow channels 13 are possible.

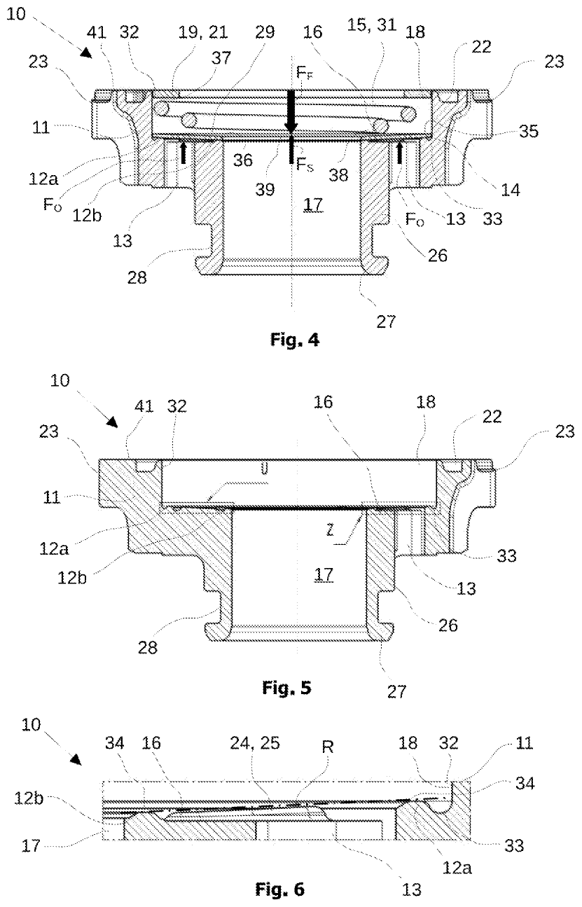

FIG. 1 and FIG. 4 show that the non-return valve 10 has, in addition to the valve body 11, a cover disc 14 and a spring element 15. The cover disc 14 and the spring element 15 are integrated in the valve body 11. Specifically, the cover disc 14 and the spring element 15 are arranged completely in the recess 18 in the valve body 11. The state of the non-return valve 10 that is shown in FIG. 4 corresponds to the unactuated state, i.e. the non-return valve 10 is in the shut-off state. In the shut-off state, the flow channels 13 are completely covered by the cover disc 14. The mode of operation of the non-return valve 10 and the different actuation states will be described in more detail later on.

The valve body 11 furthermore has two control edges 12a, 12b which encircle the central through-opening 17 at a spacing from one another. The control edges 12a, 12b extend from a bottom surface 16 of the valve body 11 into the recess 18. In other words, the two control edges 12a, 12b protrude from the bottom surface 16.

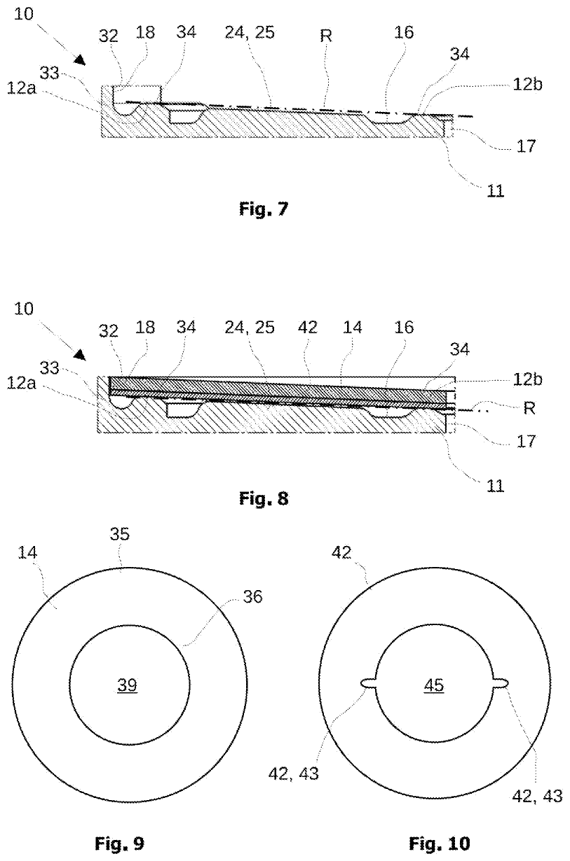

As can be seen in FIG. 2, the control edges 12a, 12b are rib-shaped rings around the central through-opening 17. FIG. 2 also shows that the flow channels 13 are formed radially between the two control edges 12a, 12b. This is enabled because a first one of the two control edges 12a is formed radially on the outside with respect to the centre axis M and a second one of the two control edges 12b is formed radially on the inside. Specifically, the first control edge 12a adjoins an inner wall 32 of the recess 18, in particular radially on the outside, and the second control edge 12b adjoins the central through-opening 17, in particular radially on the inside. A groove 33 which can be clearly seen in FIGS. 6 and 7, extends on the control edge 12a and is formed between the first control edge 12a and the inner wall 32 of the recess 18.

It can also be seen in FIGS. 6 and 7 that the first control edge 12a extends further into the recess 18 than the second control edge 12b does, in particular parallel to the centre axis M. In other words, the first control edge 12a is higher in relation to the bottom surface 16 than the second control edge 12b. Or, expressed differently, the first control edge 12a forms a higher elevation on the bottom surface 16 of the valve body 11 than the second control edge 12b.

As can be clearly seen in FIGS. 6 and 7, the two control edges 12a, 12b are offset from one another in terms of height. This means that the control edges 12a, 12b have a respective vertex, and the vertices are at different height levels in relation to the bottom surface 16. The vertex of the first control edge 12a is higher than the vertex of the second control edge 12b. The control edges 12a, 12b have a respective support surface 34 for the cover disc 14 on their upper sides. Within the context of the application, it is therefore possible for the vertices not just to be considered as one-dimensional points but also to comprise a surface portion, such as the support surfaces 34. In any case, the vertices form a termination of the control edges 12a, 12b which faces away from the bottom surface 16. In the present exemplary embodiment, the vertices of the control edges 12a, 12b comprise the support surfaces 34.

As described above, the cover disc 14 and the spring element 15 are inserted in the recess 18. This can be clearly seen in FIG. 4. FIG. 4 shows the non-return valve 10 in the shut-off state. Here, the cover disc 14 lies with a radially outer peripheral region 35 on the support surface 34 of the first, in particular elevated, control edge 12a. Furthermore, the cover disc 14 lies with a radially inner peripheral region 36 on the support surface 34 of the second, in particular lower, control edge 12b. In this state, the cover disc 14 is deformed by the spring element 15. Specifically, the spring element 15 elastically deforms the cover disc 14 from the first control edge 12a in such a way that the cover disc 14 lies with the radially inner peripheral region 36 sealingly against the second control edge 12b. In this state, of course, the radially outer peripheral region 35 of the cover disc 14 lies sealingly against the first control edge 12a. The cover disc 14 lies directly against the two control edges 12a, 12b. The spring element 14 preloads the cover disc 14 against the two control edges 12a, 12b.

In this case, the cover disc 14 is in a closed position, in which the flow channels 13 are completely shut off. In the closed position, no damping fluid can flow between the two piston working chambers 102a, 102b through the non-return valve 10. The damping fluid may be a liquid, in particular hydraulic oil, or a gas, in particular a gas mixture. The closed position of the cover disc 14 corresponds to the shut-off state of the non-return valve, in which the cover disc 14 lies sealingly against the two control edges 12a, 12b.

An actuation of the non-return valve 10, which comprises an opening operation and a closing operation, will be described below.

During an opening operation, the cover disc 14 lifts off first of all from the support surface 34 of the second, lower control edge 12b and then from the support surface 34 of the first, higher control edge 12a. This takes place in an opening direction, which runs substantially parallel to the centre axis M of the valve body 11. In this state, the cover disc 14 is spaced apart from the two control edges 12a, 12b. In other words, the cover disc 14 is not in contact with the control edges 12a, 12b here. It is alternatively possible for the cover disc 14 to lift off only from the second control edge 12b and, however, still be in contact with the first control edge 12a. This can be the case in the event of very low volumetric flows or a low opening pressure owing to the damping fluid present in the flow channels 13. In both cases, the cover disc 14 is in an open position, in which the flow channels 13 for the damping fluid are opened up, i.e. form a free passage into the recess 18. The damping fluid can flow from the first to the second piston working chamber 102a, 102b, or vice versa, depending on a compression stage or rebound stage.

During a closing operation, the spring element 15 arranges the cover disc 14 on the support surfaces 34 of the control edges 12a, 12b again counter to the opening direction. During the closing process, the cover disc 14 lies with the radially outer peripheral region 35 tightly on the support surface 34 of the first control edge 12a. During the closing process, the first control edge 12a forms a first support for the cover disc 14. The first control edge 12a delimits the closing travel of the cover disc 14 in the radially outer peripheral region 35. The spring element 15 then elastically deforms the cover disc 14 in such a way that the cover disc 14 lies with the radially inner peripheral region 36 tightly on the support surface 34 of the second control edge 12b. The second control edge 12b forms a second support for the cover disc 14. The second control edge 12b delimits the closing travel of the radially inner peripheral region 36 of the cover disc 14. The cover disc 14 makes contact with the two control edges 12a, 12b in succession during the closing operation. This results in rolling when the cover disc 14 is being closed, this having a positive effect on the generation of switching noise.

The height offset of the two control edges 12a, 12b corresponds to a deformation travel of the cover disc 14, over the length of which the spring element 15 elastically deforms the cover disc 14. The spring element 15 thus preloads the cover disc 14 against the control edges 12a, 12b, in particular in the closed position. As a result of the elastic deformation of the cover disc 14 over the length of the deformation travel, the cover disc 14 builds up a disc force FS which acts counter to a spring force FF of the spring element 15.

This has the advantage that the opening force FO necessary for the opening operation, or lifting the cover disc 14 off from the control edges 12a, 12b, is reduced. The opening force FO corresponds to the difference between the spring force FF of the spring element 15 and the disc force FS of the cover disc 14. The cover disc 14 is therefore adapted such that, in the deformed state, it applies the disc force FS that counteracts the spring force FF of the spring element 15. The directions of action of the forces FF, FS, FO are shown in FIG. 4.

The disc force FS of the cover disc 14 reduces not only the opening force FO required. The disc force FS that builds up over the deformation travel of the cover disc 14 additionally brakes the cover disc 14 during the closing process, i.e. when it is being placed on the second control edge 12b. This reduces the switching noise level and improves the dynamic behaviour of the non-return valve 10.

In order to introduce the spring force FF into the cover disc 14, the spring element 15 lies on the one hand with a first spring end 37 against an insert element 19 and on the other hand with the second spring end 38 against a surface 29 of the cover disc 14 situated opposite the control edges 12a, 12b. As shown in FIG. 4, the spring element 15 lies against the radially inner peripheral region 36 of the cover disc 14. The spring element 15 therefore radially inwardly introduces the spring force FF into the cover disc 14. The spring element 15 may alternatively be arranged or designed such that it introduces the spring force FF radially outwardly or radially centrally between the two peripheral regions 35, 36 into the cover disc 14 for deformation purposes.

The insert element 19, as shown in FIG. 4, is arranged in the recess 18. Specifically, the insert element 19 is arranged completely in the recess 18 in the valve body 11. The insert element 19 is annular and serves as a counter-bearing for the spring element 15. In other words, the insert element 19 is a support ring 21, on which the first spring end 37 of the spring element 15 is supported.

The views of a detail of FIGS. 6 and 7 each show a sectional illustration through the control edges 12a, 12b which rise from the bottom surface 16. The view of a detail according to FIG. 6 corresponds to the view of the detail “Z” in FIG. 5 and the view of a detail according to FIG. 7 corresponds to the view of the detail “U” in FIG. 5. Likewise clearly visible in FIG. 6 and FIG. 7 is the course of the flow channels 13 and a further elevation 24 between the control edges 12a, 12b. Specifically, the valve body 11 has multiple elevations 24, which are arranged radially between the two control edges 12a, 12b. The elevations 24 protrude from the bottom surface 16 and project into the recess 18 in the valve body 11. The elevations 24 extend radially between the control edges 12a, 12b.

More specifically, the elevations 24 at least partially extend between the control edges 12a, 12b. The elevations 24 have an ascending profile. In other words, the elevations 24 ascendingly extend from the first control edge 12b to the second control edge 12a. A respective spacing is provided between the elevations 24 and the control edges 12a, 12b. However, they end close to the control edges 12a, 12b. Furthermore, the elevations 24 are arranged circumferentially such that a respective one of the elevations 24 extends between two flow channels 13.

As shown in FIGS. 6 and 7, the elevations 24 are below a reference line R over their ascending profile. The reference line R is depicted by way of example between the vertices of the two control edges 12a, 12b. The reference line R constitutes a straight height profile between the two control edges 12a, 12b. The elevations form support ridges 25, which can additionally delimit the deformation travel of the cover disc 14. The use of the support ridges 25 is to ensure the cover disc 14 does not sag radially between the control edges 12a, 12b in the closed position.

In the closed position, the cover disc 14 is in the deformed state. In this state, the cover disc has a conical shape. In the open position, that is in a non-deformed state, the cover disc 14 has a substantially flat face. Or, expressed differently, the cover disc 14 is flat in the non-deformed state. It is possible for the cover disc 14 to be conically pre-formed in the non-deformed state. Other shapes are conceivable.

As is clear from FIG. 4 and FIG. 9, the cover disc 14 is annular. The cover disc 14 has a free passage 39, which is formed in the region of the central through-opening 17 in the valve body 11. It is possible that an inside diameter of the free passage 39 corresponds to an inside diameter of the central through-opening 17 in the valve body 11.

FIG. 4 likewise shows that the spring element 15 is a frustoconical spring 31. The first spring end 37 is radially wider than the second spring end 31 of the frustoconical spring 31. It is alternatively possible for the spring element 15 to be a barrel spring, a cylindrical spring or a plate spring.

In order to cover a distance between the outer tube 103 and the inner tube 104 of the vibration damper 100, the valve body 11 has an extension 26, which extends along the centre axis M. The central through-opening 17 extends through the extension 26 along the centre axis M. According to FIG. 1, it can be seen that the central through-opening 17 fluidically connects one of the piston working chambers 102a, 102b to the associated adjusting valve 101. In the closed position of the cover disc 14, the damping fluid flows through the central passage opening 17 to the adjusting valve 101 to dynamically regulate the damping.

A second sealing region 28 of the valve body 11 is formed at one longitudinal end 27 of the extension 26. It may receive a sealing element, preferably an O ring. A first sealing region 22 is formed on an end face 41 of the valve body 11 that adjoins the recess 18. The first sealing region is likewise designed to receive a sealing means, preferably an O ring. The two sealing regions 22, 28 have a respective slot. The slot in the first sealing region 22 extends around the recess 18 and the slot in the second sealing region 23 extends circumferentially around the extension 26. As can be seen for example in FIGS. 4 and 5, the extension 26 is a cylindrical peg.

The first sealing region 22 serves to seal the valve body 11 with respect to the adjusting valve 101 (see FIG. 1). The second sealing region 28 serves to tightly connect the valve body 11 to the intermediate tube 106 and to the inner tube 104 of the vibration damper 100.

FIG. 1 also shows that the valve body 11 lies on the outer circumference of a step 111 of the valve port 110 in the region of the end face 41. To this end, the valve body 11 has a collar 23 on a circumference situated opposite the extension 26 in the longitudinal direction of the centre axis. The collar 23 extends radially outwards and has a multiplicity of circumferentially evenly distributed, radially inwardly pointing cutouts 42. The cutouts 42 are preferably further flow channels, through which the damping fluid can flow from the adjusting valve 101 back to one of the piston working chambers 102a, 102b. In other words, the collar 23 has a star-shaped form. According to FIG. 1, the valve body 11 lies with the collar 23 on the step 111 of the valve port 110. The non-return valve 10 is secured, in particular clamped in, between the step 111 and the adjusting valve 101 by the collar 32.

FIG. 8 shows a view of a detail of a longitudinal section through a non-return valve 10 of a vibration damper 100 as per a further exemplary embodiment according to the disclosure. The non-return valve 10 according to FIG. 8 differs from the non-return valve 10 according to FIGS. 2 to 7 only in that a bypass disc 42 is arranged between the cover disc 14 and the two control edges 12a, 12b.

In all other respects, the non-return valve 10 according to FIG. 8 has all the features of the non-return valve 10 according to FIGS. 2 to 7.

The bypass disc 42, like the cover disc 14, is elastically deformable. It can be seen in FIG. 8 that the bypass disc 42 lies against the cover disc 14 over its entire surface area, at least in the closed position. In this position, the bypass disc 42 is in the deformed state, wherein, like the cover disc 14, it has a conical shape. In the open position, that is in the non-deformed state, the bypass disc 42 has a substantially flat face. Or, expressed differently, the bypass disc 42 is flat in the non-deformed state. It is possible for the bypass disc 42 to be conically pre-formed in the non-deformed state. Other shapes are conceivable.

It can likewise be seen in FIG. 8 that the cover disc 14 has a thickness which is larger than a thickness of the bypass disc 42. In other words, the bypass disc 42 is thinner than the cover disc 14.

As is clear from FIG. 10, the bypass disc 42 is annular. The bypass disc 42 has a free passage 45, which is formed in the region of the central through-opening 17 in the valve body 11. The free passage 39 in the cover disc 14 and the free passage 45 in the bypass disc 42 preferably correlate. The bypass disc 42 also has two bypass channels 43, which are formed radially on the inside. The bypass disc 42 may alternatively have only a single bypass channel 43 or more than two bypass channels 43. In any case, the bypass disc 42 is not restricted to two bypass channels 43.

As shown in FIG. 10, the bypass channels 43 form a respective bypass recess 44, which is radially inwardly open. The bypass recesses 44 are specifically open towards the central through-opening 17. The bypass recesses 44 are formed facing one another on an inner circumference of the bypass disc 42. In the closed position, each one of the bypass channels 43 fluidically connects one of the flow channels 13 to the central through-opening 17. This has the advantage that the switching noises during the opening and closing processes are reduced.

In the present second exemplary embodiment, during a closing operation, the cover disc 14 and the bypass disc 42 are moved counter to the opening direction by the spring element 15, wherein the bypass disc 42 is arranged on the support surfaces 34 of the control edges 12a, 12b by the cover disc 14. During the closing process, the bypass disc 42 first of all lies with a radially outer peripheral region tightly on the support surface 34 of the first control edge 12a. During the closing process, the first control edge 12a forms a first support for the cover disc 14 and the bypass disc 42. The first control edge 12a delimits the closing travel of the cover disc 14 and the bypass disc 42 in the radially outer peripheral region.

The spring element 15 then elastically deforms the cover disc 14 and thus the bypass disc 42 in such a way that the bypass disc 42 lies with a radially inner peripheral region tightly on the support surface 34 of the second control edge 12b. The second control edge 12b forms a second support for the cover disc 14 and the bypass disc 42. The second control edge 12b delimits the closing travel of the radially inner peripheral region of the bypass disc 42. The bypass disc 42 makes contact with the two control edges 12a, 12b in succession during the closing operation. This results in rolling when the cover disc 14 and the bypass disc 42 are being closed, this having a positive effect on the generation of switching noise. In the closed position, the cover disc 14 lies indirectly on the control edges 12a, 12b via the bypass disc 42.

The height offset of the two control edges 12a, 12b corresponds to a deformation travel of the cover disc 14 and the bypass disc 42, over the length of which the spring element 15 elastically deforms the cover disc 14 and the bypass disc 42. The spring element 15 thus preloads the bypass disc 42 against the control edges 12a, 12b via the cover disc 14, in particular in the closed position. In the closed position, the bypass channels 43 of the bypass disc 42 connect two of the flow channels 13 to the central through-opening 17 in the valve body 11.

As a result of the elastic deformation of the cover disc 14 over the length of the deformation travel, the cover disc 14 and the bypass disc 42 build up a disc force FS which acts counter to a spring force FF of the spring element 15. The opening force FO for the opening process, or lifting the cover disc 14 and the bypass disc 42 off from the control edges 12a, 12b, is reduced as a result. The opening operation takes place in the reverse order of the closing operation described above.

### LIST OF REFERENCE NUMERALS

10 Non-return valve
11 Valve body
12a First control edge
12b Second control edge
13 Flow channel
14 Cover disc
15 Spring element
16 Bottom surface
17 Central through-opening
18 Recess
19 Insert element
21 Support ring
22 First sealing region
23 Collar
24 Elevation
25 Support ridge
26 Extension
27 Longitudinal end
28 Second sealing region
29 Oppositely situated surface
31 Frustoconical spring
32 Inner wall
33 Groove
34 Support surface
35 Radially outer peripheral region
36 Radially inner peripheral region
37 First spring end
38 Second spring end
39 Free passage through the cover disc
41 End face of the valve body
42 Bypass disc
43 Bypass channel
44 Bypass recess
45 Free passage
100 Vibration damper
101 Adjusting valve
102a First piston working chamber
102b Second piston working chamber
103 Outer tube
104 Inner tube
105 Annular space
106 Intermediate tube
107 Piston
108 Piston rod
109 First longitudinal end of the vibration damper
110 Valve port
111 Step
FF Spring force
FS Disc force of the cover disc
FO Opening force
R Reference line
M Centre axis

What is claimed is:

1. A non-return valve for a vibration damper comprising:
a valve body having at least two control edges which are offset from one another in terms of height and at least one flow channel formed between the control edges;
at least one cover disc, which covers the flow channel in a shut-off state of the non-return valve; and
at least one spring element lying against the cover disc, wherein the spring element elastically deforms the cover disc from the first control edge in such a way that the cover disc lies sealingly against the second control edge.

2. The non-return valve of claim 1, wherein the valve body includes an inwardly recessed bottom surface, from which the control edges rise.

3. The non-return valve of claim 2, wherein the first control edge projects above the second control edge proceeding from the bottom surface, wherein the first control edge is formed radially on the inside or radially on the outside of the second control edge.

4. The non-return valve of claim 1, wherein the valve body has at least one central through-opening for the fluid, wherein the control edges annularly encircle the through-opening.

5. The non-return valve of claim 1, wherein the valve body has a recess in which the cover discs and the spring element are arranged, wherein the control edges project into the recess.

6. The non-return valve of claim 5, wherein the at least one insert element is arranged in the recess and forms a counter-bearing for the spring element.

7. The non-return valve of claim 5, wherein the valve body includes at least one first sealing region, which encircles the recess and is intended to provide sealing with respect to a mating piece, in particular an adjusting valve.

8. The non-return valve of claim 1, wherein the valve body includes at least one collar, which is arranged on a circumference of the valve body and at least partially extends in the circumferential direction.

9. The non-return valve of claim 1, wherein the valve body includes at least one elevation, in particular a support ridge, which is arranged between the control edges, wherein the elevation delimits a deformation travel of the cover disc.

10. The non-return valve of claim 9, wherein the elevation rises from the second control edge towards the first control edge, wherein the elevation extends below a reference line (R) which connects the highest points of the control edges.

11. The non-return valve of claim 1, wherein the valve body includes at least one extension, which extends along a centre axis (M) of the valve body and at the longitudinal end of which at least one second sealing region is formed.

12. The non-return valve of claim 1, wherein the spring element lies against a surface of the cover disc that is situated opposite the control edges, wherein the spring element introduces its spring force (FF) radially inwardly, radially outwardly and/or radially centrally into the cover disc.

13. The non-return valve of claim 1, wherein the spring element comprises a frustoconical spring, a barrel spring, a cylindrical spring and/or a plate spring.

14. The non-return valve of claim 1, wherein the cover disc includes a flat or frustoconical form in the non-deformed state.

15. The non-return valve of claim 1, wherein at least one bypass disc is arranged between the cover disc and the two control edges, wherein the bypass disc has at least one bypass channel, in particular at least one bypass recess and/or at least one bypass opening, which forms a passage to the flow channel in the shut-off state of the non-return valve.

16. The non-return valve of claim 15, wherein the bypass disc is annular, wherein the bypass channel is formed radially on the inside and/or radially on the outside.

17. A vibration damper comprising:
at least one non-return valve of claim 1, wherein the non-return valve is arranged between at least two piston working chambers of the vibration damper and, during a compression stage and/or a rebound stage, fluidically connects the two piston working chambers to one another or shuts them off from one another.

18. A system for using a non-return valve of claim 1 comprising:
at least one adjusting valve, at least one base valve, at least one rectifying valve arrangement and/or at least one valve flange, in combination with the non-return valve.
